(19) United States
(12) Patent Application Publication
(10) Pub. No.: US 2025/0019871 A1
(43) Pub. Date: Jan. 16, 2025

(54) COMPONENT WITH OPTICAL FIBERS AND LIGHT COUPLING DEVICE AND METHOD FOR MANUFACTURING THE COMPONENT

(71) Applicant: JOYSONQUIN Automotive Systems GmbH, Rutesheim (DE)

(72) Inventors: Philip FRUCHT, Renningen (DE); Stefan BROMMER, Tamm (DE)

(21) Appl. No.: 18/765,283

(22) Filed: Jul. 7, 2024

(30) Foreign Application Priority Data
Jul. 14, 2023 (DE) 102023118694.9

(51) Int. Cl. D03D 15/547; B60Q 3/54; D03D 15/283

(52) U.S. Cl. CPC D03D 15/547; B60Q 3/54; D03D 15/283; D10B 2401/20

(57) ABSTRACT

A decorative part for a vehicle interior, comprising a fabric layer with one or more optical fibers woven into it and at least one light coupling device, via which light can be coupled into the optical fibers. The light coupling device comprises a translucent injection-molded first plastic component with the ends of the optical fibers embedded in the first plastic component with a material bond. A method for manufacturing the component comprising the steps of: providing a fabric layer with one or more optical fibers woven into it, wherein the ends of the optical fibers protrude from the fabric layer; inserting the fabric layer into a first injection mold and overmolding the ends of the optical fibers with a translucent first plastic component to form a material bond between the ends of the optical fibers and the first plastic component; and forming the first plastic component into a light coupling device via which light can be coupled into the optical fibers.

### FIELD OF THE INVENTION

The present invention relates to a component, in particular a decorative part for a vehicle interior, comprising a fabric layer with optical fibers woven into it, and to a method for manufacturing the component.

### BACKGROUND OF THE INVENTION

Components made of light-conducting fabrics are known in the prior art. Such components can in particular be used for decorative purposes, for example as decorative outer cladding of a device. For example, decorative parts with light-conducting fabrics are used to cover the interior of vehicles. Light-conducting fabrics usually consist of a flat carrier material, for example a textile fabric, with fibers of a light-conducting material woven into it. The light-conducting fibers are configured in such a way that they not only transport light in the longitudinal direction, but that the light is also coupled out in the transverse direction to the fiber. In this way, the fabric can be extensively illuminated. The lateral coupling out of light can be generated by suitable surface treatment and/or doping of the fibers and by selecting suitable bending radii.

An example of a component with a light-conducting fabric is disclosed in DE 10 2012 013 105 A1. This component comprises a multi-layered textile fabric, wherein optical fibers for light emission are provided in a first layer and a second layer adjacent to the first layer is configured as a protective layer. In this case, the optical fibers are made of polymethacrylic acid ester, polystyrene or polycarbonate, for example.

Another example of a textile fabric with a light-conducting fabric is disclosed in DE 10 2007 018 227 A1. This fabric comprises a carrier material and a plurality of bundles of light-conducting fibers which are attached to the carrier material by at least one thread. In one embodiment, the laminar structure is embedded in a translucent carrier, in particular laminated or molded in. The light-conducting fibers are preferably formed from glass fibers.

A disadvantage in the manufacture of woven or knitted fabrics with optical fibers is their connection to a light source. In some cases, the optical fibers have to be manually integrated into devices and fixed to light coupling elements. This process is unfavorable in terms of costs and is associated with a high error rate. In addition, the connections between a light source and the actual illuminated fabric require some space, as bending radii must be maintained.

### SUMMARY OF THE INVENTION

The present invention describes a possibility for remedying the above-mentioned disadvantages and for enabling economical production of such components. It is thus the object of the invention to provide a component with a light-conducting fabric which enables simple coupling between the optical fibers of the light-conducting fabric and an external light source. It is furthermore the object of the invention to provide a method by which such a component can be produced at low cost, in large quantities and with high precision.

This problem is solved by a component and a method for manufacturing the component.

The invention is based on the basic idea of forming a light coupling device from an injection-molded plastic component in which the ends of the optical fibers of a light-conducting fabric are embedded in a material bond. In this way, light can be coupled into the optical fibers. Manufacturing the light coupling device by overmolding the ends of the optical fibers with a plastic material proves to be a simple solution for fixing the optical fibers to the light coupling device. In this way, the component according to the invention can be manufactured in large quantities and with a low error rate. In addition, the injection molding process allows great flexibility in the shape, number and arrangement of the light coupling devices.

### Component

The present invention relates to a component, in particular a decorative part for a vehicle interior, comprising a fabric layer with one or more optical fibers woven into it and at least one light coupling device via which light can be coupled into the optical fibers. The component is characterized in that the light coupling device comprises a translucent injection-molded first plastic component and the ends of the optical fibers are embedded in the first plastic component in a materially bonded manner.

For the purposes of the invention, any material with a textile appearance into which optical fibers can be woven can be used as a fabric layer. The fabric layer can thus comprise, for example, a woven fabric, interlaced yarns, knitted fabric or non-woven fabric into which the optical fibers are woven. The fabric layer can, for example, comprise natural fibers, synthetic fibers, glass fibers and metal fibers.

The production of a fabric layer with one or more optical fibers woven into it is basically known to the person skilled in the art. Such methods are disclosed, for example, in DE 10 2007 018 227 A1 and DE 10 2012 013 105 A1 and in the references cited therein. However, no means are disclosed in the prior art by which the optical fibers can be coupled to a light source in a simple manner.

In one embodiment, the component comprises at least one light source which is connected to the light coupling device in a light-conducting manner, so that the light from the light source can be coupled into the optical fibers via the light coupling device. The light source used is in particular an electric light source, preferably an LED. The light source can, for example, optionally generate white light or colored light. It is also possible for the component to have several light sources for generating light of different colors, for example a plurality of LEDs of different colors. In this case, the component preferably also has a control unit with which different light sources can be selectively switched on and off in order to illuminate the component in different colors.

The optical fibers consist of a light-conducting material that can form a material bond with the first plastic component. Preferably, the optical fibers are made of plastic, particularly preferably of a thermoplastic material. Suitable plastics for manufacturing the optical fibers are, for example, polymethacrylic acid esters (PAAM), polystyrenes (PS) or polycarbonates (PC). In a preferred embodiment, the optical fibers consist of polymethacrylic acid ester.

In order to enable a material bond between the ends of the optical fibers and the first plastic component, the melting points of the first plastic component and the material of the optical fibers should be matched to each other. Preferably, this means that the material of the first plastic component has a higher melting point than the material of the optical fibers.

The light coupling device is essentially formed by the injection-molded first plastic component. This is formed in such a way that light from a light source can be radiated into the light coupling device. Due to the fact that the ends of the optical fibers are embedded in the first plastic component, the light from the light source can be coupled into the optical fibers.

As explained below, the component can have several functionally separate light coupling devices. This also requires several plastic components. In principle, within the scope of the invention, each plastic component may be connected to one or more optical fibers. Preferably, however, each individual first plastic component is simultaneously connected to the ends of several optical fibers. Thus, several optical fibers are always combined into a group and are each connected as a group to a light coupling device. The advantage of the invention is thus that several optical fibers can be simultaneously connected to a light coupling device in one injection molding step and that the several optical fibers can be coupled to a light source in one step.

In one embodiment, the component comprises a plurality of optical fibers and a plurality of light coupling devices, each of which is connected to different optical fibers so that light can optionally be coupled into one or more optical fibers via one or more light coupling devices. The ends of the individual optical fibers are therefore not embedded in a single, uniform plastic component, but in functionally separate plastic components, each of which forms separate light coupling devices. In this case, the optical fibers can also be combined in groups and each connected to a light coupling device. With this embodiment, it is possible, for example, to selectively illuminate only some of the optical fibers or to illuminate different optical fibers from different light sources, for example with different colored light.

In this embodiment, the light coupling devices are preferably functionally separated from one another such that light is only coupled into the optical fibers connected to this light coupling device via a specific light coupling device and no light scatters into the other optical fibers. This functional separation can be created by spatially and/or optically separating the light coupling devices. For example, the light coupling devices can be spaced apart in such a way that the light from one light coupling device does not reach a neighboring light coupling device. Furthermore, a layer of opaque material can be provided between adjacent light coupling devices in order to optically separate the light coupling devices from each other.

Preferably, in this embodiment, the component has a plurality of light sources, each of which is assigned to individual light coupling devices and emits its light only into the respectively assigned light coupling devices.

Preferably, the component in this embodiment also has a control unit with which different light sources can be selectively switched on and off in order to selectively illuminate individual light coupling devices and the optical fibers connected to them. Using this control unit, aesthetically interesting effects can be achieved by switching individual optical fibers on and off in a time-controlled manner. For example, spatially adjacent optical fibers can be illuminated one after the other and thus an animation effect can be achieved.

In a preferred embodiment, the component comprises a first group of substantially parallel optical fibers and a second group of substantially parallel optical fibers, wherein the optical fibers of the first group are arranged to cross the optical fibers of the second group, and wherein the optical fibers of the first group and the optical fibers of the second group are each connected to different light coupling devices so that light can be optionally coupled into the optical fibers of the first group and/or the optical fibers of the second group. Interesting stripe patterns can be created with this embodiment.

In a further development of this embodiment, the substantially parallel optical fibers of a group are also each connected to different light coupling devices, so that light can optionally be coupled into all and/or individual optical fibers of a group.

Due to its preferably flat structure, the fabric layer according to the invention has two opposing main surfaces, which are referred to as the visible side and the carrier side in the context of the present invention. When the decorative part is used as intended, the visible side faces the viewer, while the carrier side forms the side of the decorative part facing away from the viewer.

In addition, the fabric layer has side surfaces that are essentially at right angles to the aforementioned main surfaces. The ends of the optical fibers protrude from the fabric layer in the direction of the side surfaces and are embedded in the plastic component of the light coupling device.

The light coupling device is preferably arranged along these side surfaces. This arrangement is also referred to as “lateral” in the context of the invention. In a preferred embodiment, the light coupling device is arranged so as to laterally surround the fabric layer. In other words, the light coupling device is arranged along all side surfaces and forms a frame that surrounds the fabric layer. In this way, the light coupling device also contributes to the mechanical stability of the decorative part.

Parts of the light coupling device can also be arranged on the carrier side of the component. In this way, light from a light source arranged on the carrier side can be coupled into the component.

The carrier side of the fabric layer is preferably fixed to a carrier plate. The carrier plate is made of plastic, for example, preferably translucent plastic. The fabric layer is preferably fixed to the carrier plate by means of an adhesive layer. The adhesive layer preferably covers the entire carrier side of the fabric layer.

According to a preferred embodiment of the present invention, the carrier plate is made of a foamed material, in particular a foamed plastic material is used. The foamed plastic material can be deformed easily and provides a rather soft support for carrying the light guide. Thus, in case of an external force acting on at least one of the optical fibers, the optical fiber can yield this external force by moving backwardly and into the carrier, which carrier will plastically and and/or elastically be deformed. Thus, the foamed material will secure optimum light transmission through the optical fiber and avoid kinking of the fiber material in case of an external pressure acting on the light guiding component.

In order to prevent damage to the fabric layer, the visible side of the fabric layer is preferably covered with a translucent plastic layer. The translucent plastic layer can be laminated onto the fabric layer in the form of a film. Alternatively, the plastic layer can also be applied to the fabric layer by injection molding.

The component according to the invention is in particular a decorative part for a vehicle interior. For example, the component can serve in this function as part of the interior trim of a vehicle interior. It can be used, for example, in motor vehicles, in particular cars and trucks, trains and airplanes. The component is particularly suitable as part of the dashboard, the door trim or the roof trim of vehicle interiors. In addition, the component can also be used as wall cladding in buildings.

### Manufacturing Method

The present invention also relates to a method for manufacturing the component described above. The method comprises the following steps:
providing a fabric layer with one or more optical fibers woven into it, wherein the ends of the optical fibers protrude from the fabric layer;
inserting the fabric layer into a first injection mold and overmolding the ends of the optical fibers with a translucent first plastic component to form a material bond between the ends of the optical fibers and the first plastic component; and
forming the first plastic component into a light coupling device via which light can be coupled into the optical fibers.

With the method according to the invention, it is possible to manufacture the component according to the invention cost-effectively and in large quantities. By overmolding the ends of the optical fibers, a material bond between the ends and the plastic component is ensured. In this way, the optical fibers and the plastic component are connected to each other in a light-conducting manner.

Preferably, the method according to the invention comprises a further step in which the light coupling device is connected to a light source in a light-conducting manner so that the light from the light source can be coupled into the optical fibers via the light coupling device.

The temperature during overmolding of the ends of the optical fibers is primarily based on the melting point of the first plastic component, which is injected into the injection mold in molten form. The temperature during overmolding is preferably higher than the melting point of the first plastic component. In order to promote a material bond between the first plastic component and the ends of the optical fibers, the first plastic component is preferably injected at a temperature that is higher than the melting point of the material of the optical fibers. In this way, the ends of the optical fibers are melted at least on the surface during overmolding, so that the molten material of the optical fibers and the molten first plastic component flow into each other.

Preferably, the fabric layer is fixed to a carrier plate before being inserted into the first injection mold. The carrier plate is preferably a plastic plate. This is preferably provided with an adhesive layer before it is brought into contact with the fabric layer, so that the fabric layer and carrier plate can be adhered together. Alternatively, the adhesive layer can also be applied to the fabric layer before it is brought into contact with the carrier plate.

In a preferred variant of the method, the fabric layer is at least partially overmolded with a translucent second plastic component to form a translucent plastic layer before overmolding with the first plastic component, or at least partially laminated with a film of a translucent second plastic component. In this way, a protective cover layer can be applied to the fabric layer. The overmolding with the second plastic component preferably takes place in a different injection mold than the overmolding with the first plastic component. In this case, the fabric layer is transferred from the first to the second injection mold after overmolding with the second plastic component.

The material of the second plastic component preferably has a higher melting point than the material of the first plastic component. In this way, melting of the translucent plastic layer is prevented during overmolding with the first plastic component, so that the light coupling device and the translucent plastic layer do not bond with each other.

### BRIEF DESCRIPTION OF THE DRAWINGS

The present invention is explained in more detail below with reference to embodiments in conjunction with the drawing. In the drawing it is shown by:

FIG. 1: a conventional component with a light-conducting fabric according to the prior art;

FIG. 2: an intermediate product for the manufacture of a component according to the invention;

FIG. 3: an intermediate step of the manufacturing process according to the invention;

FIG. 4: an intermediate step of the manufacturing process according to the invention;

FIG. 5: a component according to a first embodiment of the invention;

FIG. 6: a component according to a second embodiment of the invention; and

FIG. 7: a component according to a third embodiment of the invention.

### DETAILED DESCRIPTION OF THE PREFERRED EMBODIMENTS

FIG. 1 shows a conventional component with a light-conducting fabric according to the prior art. The component comprises a fabric layer 1 of non-optical fibers 2, which are shown here in cross-section, and a woven-in optical fiber 3. For a better overview, only one optical fiber 3 is shown. In fact, the fabric layer 1 can also have a plurality of optical fibers 3, which can run parallel and/or diagonally to each other. Similarly, the fabric layer 1 can have additional non-light-conducting fibers that run diagonally to the non-light-conducting fibers 2 shown schematically in FIG. 1.

In this example, the fabric layer 1 consisting of the optical fibers 3 and the fibers 2 is attached to a translucent carrier plate 5 by means of an adhesive layer 4. The carrier plate thus defines the carrier side of the component.

The component according to FIG. 1 corresponds in principle in its structure to a component according to the invention, wherein, however, no light coupling device is provided. Instead, the ends of the optical fiber 3 protruding laterally from the fabric layer 1 must be coupled individually to a light source 8 in order to illuminate the optical fibers 3.

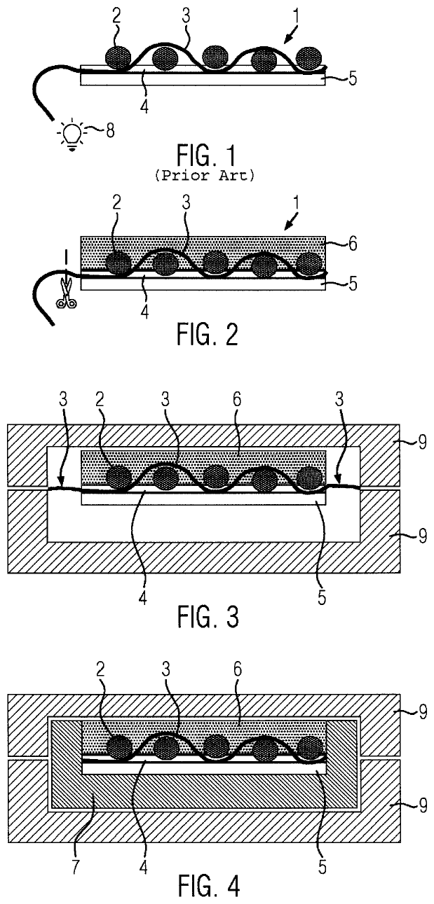

FIG. 2 shows a variant of the component shown in FIG. 1, in which the component also has a translucent plastic layer 6 in which the fabric 1 is embedded. In the example shown here, this is an injection-molded plastic layer 6. Instead of the injection-molded plastic layer 6, a plastic film laminated onto the fabric could also be used. The plastic layer 6 forms the visible side of the component and protects the fabric from damage. The ends of the optical fibers 3 protrude laterally from the composite of fabric layer 1 and plastic layer 6.

The component according to FIG. 2 can be used as an intermediate product for manufacturing the component according to the invention. For this purpose, the ends of the optical fibers 3 can be shortened to the desired length before insertion into the first injection mold, in which the ends of the optical fibers 3 are overmolded with a translucent first plastic component.

FIG. 3 shows a step in the manufacturing method according to the invention. The component shown in FIG. 2 with laterally protruding optical fibers 3 is inserted into an injection mold 9. The injection mold 9 forms a cavity into which a plastic component can be injected. The ends of the optical fibers 3 protruding from the component are arranged in this cavity in such a way that they can be overmolded with the plastic component. In the embodiment shown, the ends of the optical fibers 3 are arranged essentially parallel to the separation plane of the two-part injection mold 9. The cavity defined by the injection mold 9 extends both over the lateral outer circumference and on the carrier side of the component.

FIG. 4 shows a step of the manufacturing method according to the invention after the injection of a first plastic component into the injection mold 9 shown in FIG. 3. The Figure shows the component according to FIG. 2 which has been overmolded laterally and from the carrier side with the first plastic component. The ends of the optical fibers 3 are embedded in the first plastic component by overmolding. In this way, the ends of the optical fibers 3 are materially bonded to the first plastic component. Since the first plastic component consists of a translucent material, it forms a light coupling device 7 in this way.

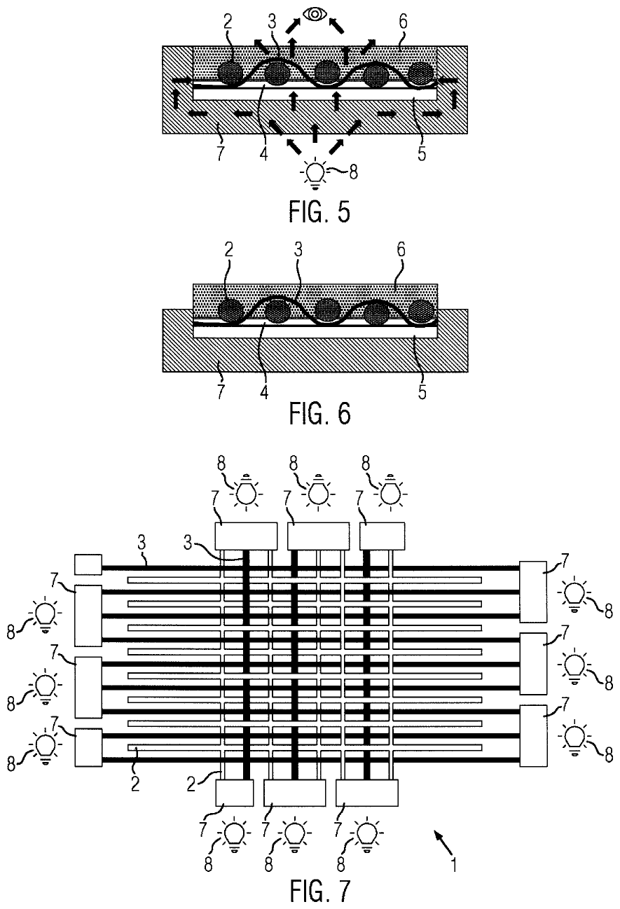

FIG. 5 shows a first embodiment of a component according to the invention. This embodiment results after demolding the component from the injection mold shown in FIG. 4. The component has a light coupling device 7 made of an injection-molded first plastic component, in which the ends of the optical fibers 3 are embedded with a material bond. The light coupling device 7 surrounds the component laterally and on the carrier side. This makes it possible, for example, to illuminate the entire component by means of a light source 8 arranged on the carrier side.

The component additionally comprises an injection-molded plastic layer 6, in which the light-conducting fabric layer 1 is embedded. The plastic layer 6 forms the visible side of the component and is flush with the light coupling device 7, so that an essentially smooth surface is formed on the visible side.

The light-conducting fabric layer 1 comprises the optical fibers 3 and non-light-conducting fibers 2 already shown in FIG. 1. The fabric layer 1 is attached to a translucent carrier plate 5 by means of an adhesive layer 4. Since both the carrier plate 5 and the plastic layer 6 are translucent, some of the light coupled into the light coupling device 7 can illuminate the fabric 1 from the carrier side. In combination with the optical fibers 3, which are also illuminated, this can result in an interesting appearance of the component.

FIG. 6 shows a second embodiment of the component according to the invention, which is essentially similar to the first embodiment of FIG. 5. In contrast to the first embodiment, however, the plastic layer 6 is not flush with the light coupling device 7, but protrudes beyond the light coupling device 7 towards the visible side.

FIG. 7 shows a third embodiment of the component according to the invention in top view from the visible side. In this embodiment, the component has a fabric layer 1 of intersecting non-optical fibers 2 and interwoven, also intersecting optical fibers 3. The ends of the optical fibers 3 protruding laterally from the fabric are each embedded in a first plastic component of a light coupling device 7 with a material bond. In contrast to the embodiments shown above, however, the component according to this embodiment comprises not just one, but several, spatially separated light coupling devices 7. The light coupling devices 7 are each connected only to individual optical fibers 3.

Due to the fact that the light coupling devices 7 are spatially separated from each other and only connected to individual optical fibers 3, the optical fibers 3 can each be illuminated by different light sources 8. This makes it possible to selectively illuminate individual optical fibers 3. For example, with the component according to FIG. 8, it is possible to illuminate only the optical fibers 3 that run transversely or vertically in the Figure. It is also possible to illuminate only individual parallel optical fibers 3. The light-conducting fabric can thus be illuminated in rows and/or columns. An animation can also be generated by sequentially switching the light sources 8 on and off. For example, a wave pattern can be generated by sequentially illuminating optical fibers 3 running in parallel.

### LIST OF REFERENCE SIGNS

1 light-conducting fabric layer
2 non-optical fibers
3 optical fibers
4 adhesive layer
5 carrier plate
6 plastic layer
7 light coupling device
8 light source
9 injection mold

What is claimed is:

1. Component, in particular a decorative part for a vehicle interior, comprising:
a fabric layer with one or more optical fibers woven into it and at least one light coupling device via which light can be coupled into the optical fibers,
wherein the light coupling device comprises a translucent injection-molded first plastic component and the ends of the optical fibers are embedded in the first plastic component with a material bond.

2. Component according to claim 1, comprising:
at least one light source which is connected to the light coupling device in a light-conducting manner, so that the light from the light source can be coupled into the optical fibers via the light coupling device.

3. Component according to claim 1, wherein:
the optical fibers are made of plastic.

4. Component according to claim 1, wherein:
the material of the first plastic component has a higher melting point than the material of the optical fibers.

5. Component according to claim 1, wherein:
the component comprises a plurality of optical fibers and a plurality of light coupling devices, each connected to different optical fibers, so that light can be optionally coupled into one or more optical fibers via one or more light coupling devices.

6. Component according to claim 1, wherein:
the component comprises a first group of substantially parallel optical fibers and a second group of substantially parallel optical fibers, wherein the optical fibers of the first group are arranged to cross the optical fibers of the second group, and wherein the optical fibers of the first group and the optical fibers of the second group are each connected to different light coupling devices so that light can be optionally coupled into the optical fibers of the first group and/or the optical fibers of the second group.

7. Component according to claim 1, wherein:
the light coupling device laterally surrounds the fabric layer.

8. Component according to claim 1, wherein:
the component comprises a carrier plate on which the fabric layer is fixed.

9. Component according to claim 1, wherein:
the fabric layer is at least partially overmolded with a translucent plastic layer.

10. Component according to claim 1, wherein:
the fabric layer is at least partially laminated with a translucent plastic film.

11. Component according to one of claim 8, wherein:
the carrier plate is made of foamed plastic material.

12. Method for manufacturing a component comprising the steps of:
providing a fabric layer with one or more optical fibers woven into it, wherein the ends of the optical fibers protrude from the fabric layer;
inserting the fabric layer into a first injection mold and overmolding the ends of the optical fibers with a translucent first plastic component to form a material bond between the ends of the optical fibers and the first plastic component; and
forming the first plastic component into a light coupling device, via which light can be coupled into the optical fibers.

13. Method according to claim 12, wherein:
the light coupling device is connected to a light source in a light-conducting manner, so that the light from the light source can be coupled into the optical fibers via the light coupling device.

14. Method according to claim 13, wherein:
the first plastic component is injected at a temperature which is higher than the melting point of the material of the optical fibers.

15. Method according to claim 13, wherein:
the fabric layer is fixed on a carrier plate before insertion into the first injection mold.

16. Method according to claim 12, wherein:
the fabric layer is at least partially overmolded with a translucent second plastic component to form a translucent plastic layer before overmolding with the first plastic component, or is at least partially laminated with a film of a translucent second plastic component.

17. Method according to claim 12, wherein:
the fabric layer is at least partially laminated with a film of a translucent second plastic component.

18. Method according to 16, wherein:
the material of the second plastic component has a higher melting point than the material of the first plastic component.

19. Method according to claim 15, wherein:
a foamed plastic material is used as the carrier plate.

20. A component for a decorative part comprising:
a fabric layer having edges;
optical fibers woven into said fabric layer, said optical fibers having ends extending beyond the edges of said fabric layer; and
a translucent injection-molded plastic formed adjacent the edges of said fabric layer and around the ends of said optical fibers, wherein the ends of the optical fibers are embedded in said translucent injection-molded plastic,
whereby a material bond is formed between the ends of said optical fibers and said translucent injection-molded plastic resulting in light coupling between said optical fibers and said translucent injection-molded plastic.
